(19) United States
(12) Patent Application Publication
(10) Pub. No.: US 2014/0214845 A1
(43) Pub. Date: Jul. 31, 2014

(54) PRODUCT CLASSIFICATION INTO PRODUCT TYPE FAMILIES

(71) Applicant: WAL-MART STORES, INC., Bentonville, AR (US)

(72) Inventors: Nikesh Lucky Garera, Mountain View, CA (US); Narasimhan Rampalli, Los Altos, CA (US); Dintyala Venkata Subrahmanya Ravikant, San Bruno, CA (US); Srikanth Subramaniam, San Jose, CA (US); Chong Sun, Redwood City, CA (US); Heather Dawn Yalin, Alameda, CA (US)

(73) Assignee: Wal-Mart Stores, Inc., Bentonville, AR (US)

(21) Appl. No.: 13/756,467

(22) Filed: Jan. 31, 2013

(51) Int. Cl. G06F 17/30

(52) U.S. Cl. CPC G06F 17/30598
USPC 707/740

(57) ABSTRACT

The present disclosure extends to methods, systems, and computer program products for updating a database with new products by classifying the new products within a hierarchy, and then using the hierarchy to improve the classification by including other product types within the classification for the new products.

### BACKGROUND

Retailers often have databases and warehouses full of thousands upon thousands of products offered for sale, with new product items being added and offered every day. Accordingly, the databases must be updated with these new products in an organized and usable manner. Each existing product and new product item should be categorized within the database so that it can be found by customers for purchase or employees for stocking. The large number of products offered for sale by a merchant makes updating a merchant's product database human labor intensive and costly if manual labor is used in the current methods and systems. On the other hand, computer based systems can pose accuracy problems that is unacceptable in the current market place.

These problems and other problems persist even with the use of computers and current computing systems. The disclosed methods and systems herein, provide more efficient and cost effective methods and systems for merchants to keep product databases up to date with new product offerings. More specifically, the disclosed methods and systems herein involve computer program products for updating a database with new products by classifying the new products within a hierarchy, and then using the hierarchy to improve the classification by including other product types within the classification for the new products.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation;

FIG. 4 illustrates a hierarchy as described herein;

FIG. 5 illustrates a hierarchy as described herein;

FIG. 6 illustrates a hierarchy as described herein; and

FIG. 7 illustrates a hierarchy as described herein.

### DETAILED DESCRIPTION

The present disclosure extends to methods, systems, and computer program products for updating a merchant's database with new product items on a merchant's network. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

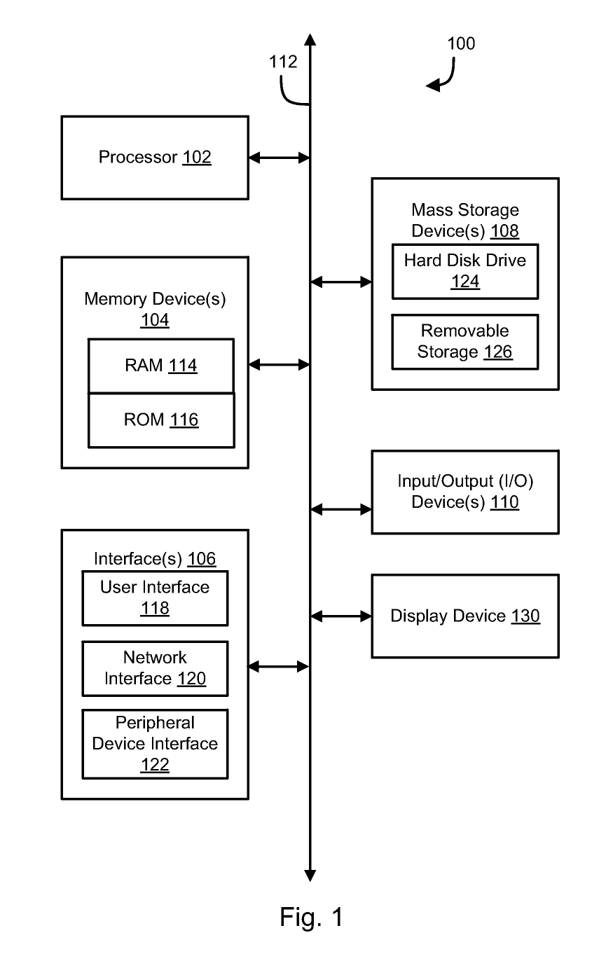

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

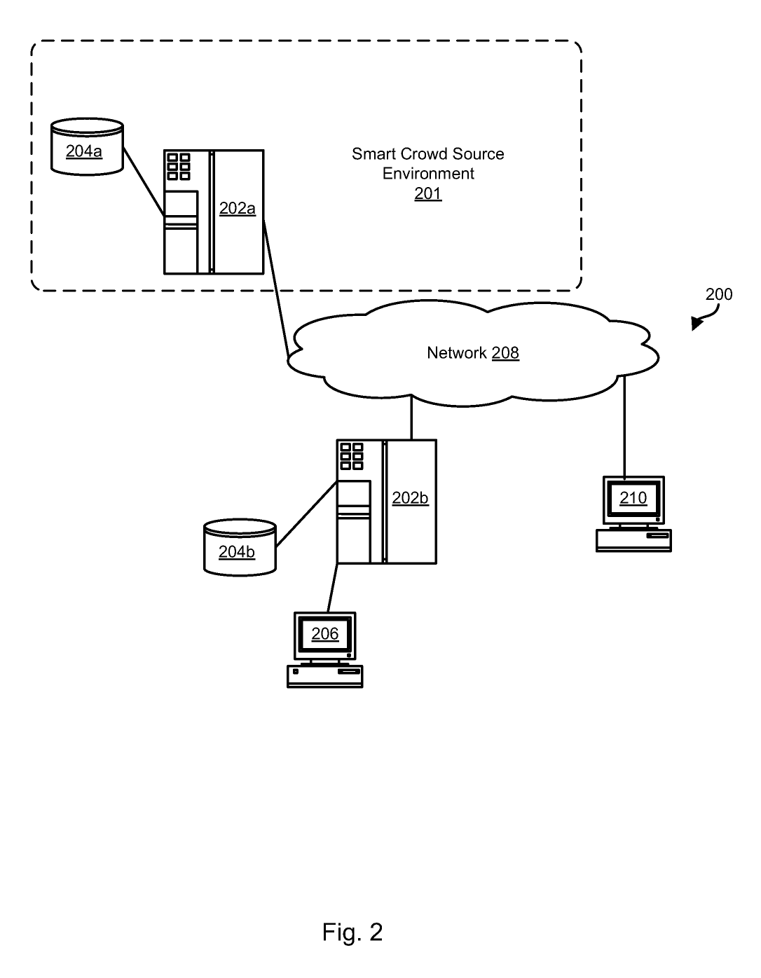

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein a smart crowd source environment is a group of users connected over a network that may be assigned tasks to perform over the network in mass. In an implementation the smart crowd source may be in the employ of a merchant, or may be contracted with on a per task basis as may be common in the crowd source community The work product from the smart crowd source is generally conveyed back to the system over the same network that supplied the tasks to be performed. In the implementations that follow, users or members of a smart crowd source may be tasked with reviewing the computer generated classification of new product items to insure that the automatically performed processes of the method have created a classification that is accurate, complete and relevant. In an implementation, a smart crowd source may be presented with a hierarchy of products within a merchant's database that also comprises the classification of the new product placed within the hierarchy relative to existing items in the hierarch, and accordingly check to see if the new product item is placed correctly in the hierarchy.

As used herein, a top down hierarchy is intended as a data structure that may comprise successive levels and nodes that represent departments and product types in order to organize a merchant's database.

A server 202b may be associated with a merchant or by another entity or party providing merchant services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

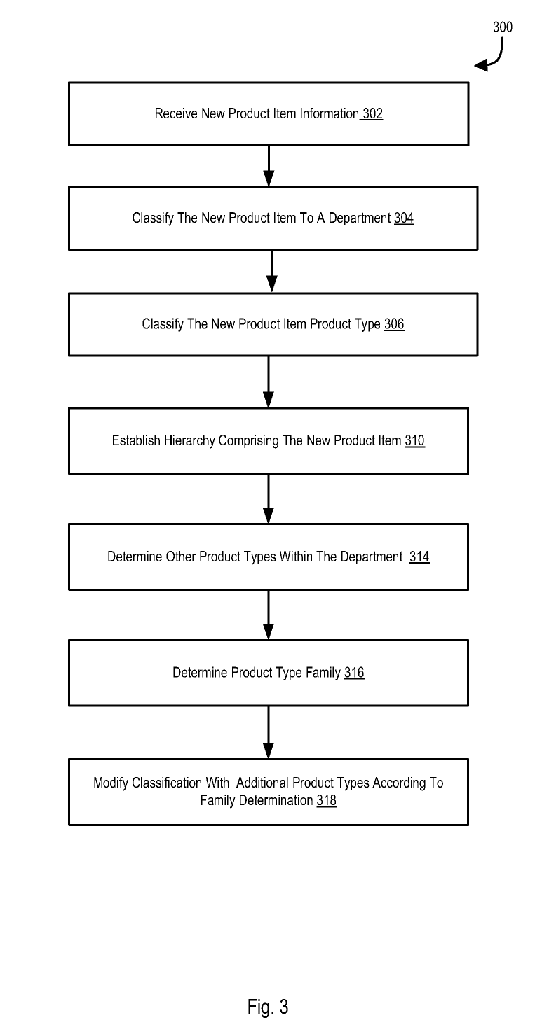

With reference to FIGS. 3, 4, 5, 6, and 7, an implementation of a method 300 for updating a merchant's database through semantic product classification and hierarchy placement will be discussed. FIG. 1 and FIG. 2 may be referenced secondarily during the discussion in order to provide hardware support for the implementation. The disclosure aims to disclose methods and systems to allow a new product item to be automatically and efficiently added to a product database. For example, a product item may have a text based description and title associated with it that provides information that can be used and quantified for classifying the new product item within a merchant's database. In an implementation the title and description alone may be combined to form product item information that may be used to semantically analyze and classify a product item so that it can properly be categorized within a database automatically.

The method 300 may be performed on a system that may include the database storage 204a (or any suitable memory device disposed in communication with the network 208) receiving a new product item information 302 representing the new product item to be sold by a merchant. The product item information may be stored in memory located within computing environment 200. The product item information may be received in digital form from an electronic database in communication with the merchants system, or may be manually input by a user. The product item information may comprise a title, a description, parameters of use and performance, and any other suitable information associated with the product that may be of interest in a merchant environment for classifying and categorizing the product item.

At 304, the system may classify the new product item to a specific department within the merchant's database through a classification model performed within the computing environment 200. The department may also be part of the merchant's brick and mortar organization. At 306, the new product item may be classified to a product type within the merchant's database through a classification model performed within the computing environment 200. A classification model for the new product item based on the product item information received at 302. A classification model may be used within the computing environment 200 to quantify text based values from the product information that represents properties of the new product item. The classification model may classify the new product item by performing a semantic algorithm, or series of semantic algorithms, against the properties provided in the new product item information in order to categorize the new product item relative to existing products items already in a merchant's database. Examples of classification models are: Naïve Bayes, K-Nearest-Neighbors, SVM, logistic regression, and multiclass perceptron, to name just a few. It should be understood that any classification model that is known or yet to be discovered is to be considered within the scope of this disclosure. It is to be contemplated that the first classification model may comprise a single algorithm or a plurality of algorithms in order to classify the new product item with desired accuracy. The classification model and results may be stored in memory within computing environment 200.

At 310, a top down hierarchy may be established comprising the new product item classification such that the new product item is placed within the top down hierarchy according to its classification relative to existing items classification also appearing in the top down hierarchy. The top down hierarchy may be stored in memory within computing environment 200. The top down hierarchy may be presented to a plurality of users for smart crowd source review. The smart crowd source review may be used to check the new product classification for accuracy and relevancy.

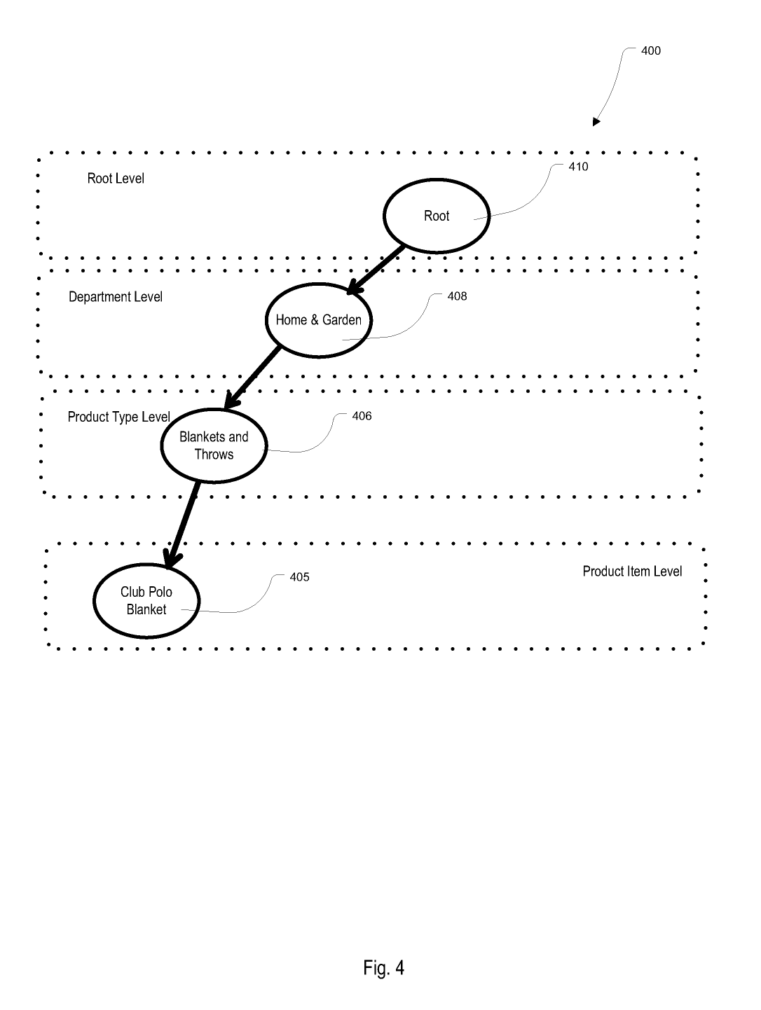

The top down hierarchy may comprise the designation of levels such that there may be a Root level, a Department level, a Product Type level, and Product Item level as illustrated in FIG. 4.

For example, a new product item 405 may be classified by the classification model at 304 as a “Club Polo Blanket” 405 and may be further classified to be sold through the merchant's “Home and Garden” department 408. The classification model at 306 may further classify the blanket to be of product type 406 “Blankets and Bedding” within the organization of the merchant. Accordingly, a top down hierarchy 400 established at 310 may have a path for the new product item 405 as being the Root 410, “Home and Garden” department 408, “Blankets and Throws” product type 406 as illustrated in FIG. 4. It should be noted that hierarchy may have a root level as the uppermost level within the hierarchy that is designated by the merchant's system and organization.

Additionally, if by chance that the classification models missed markers (such as key words, codes, images, or other machine recognizable data) in the new product item information that denoted the product (tires, for example) were for a scale model, the scale model tires may appear in the merchant's data base as full size tires for an actual automobile. A smart crowd user could readily spot such an anomaly and provide corrective information. The smart crowd corrections may be added to the product classification and stored within memory of the computing environment 200. It should be noted that the smart crowd users may be connected over a network, or may be located within a brick and mortar building owned by the merchant. The smart crowd users maybe employees and representatives of the merchant, or may be outsourced to smart crowd communities.

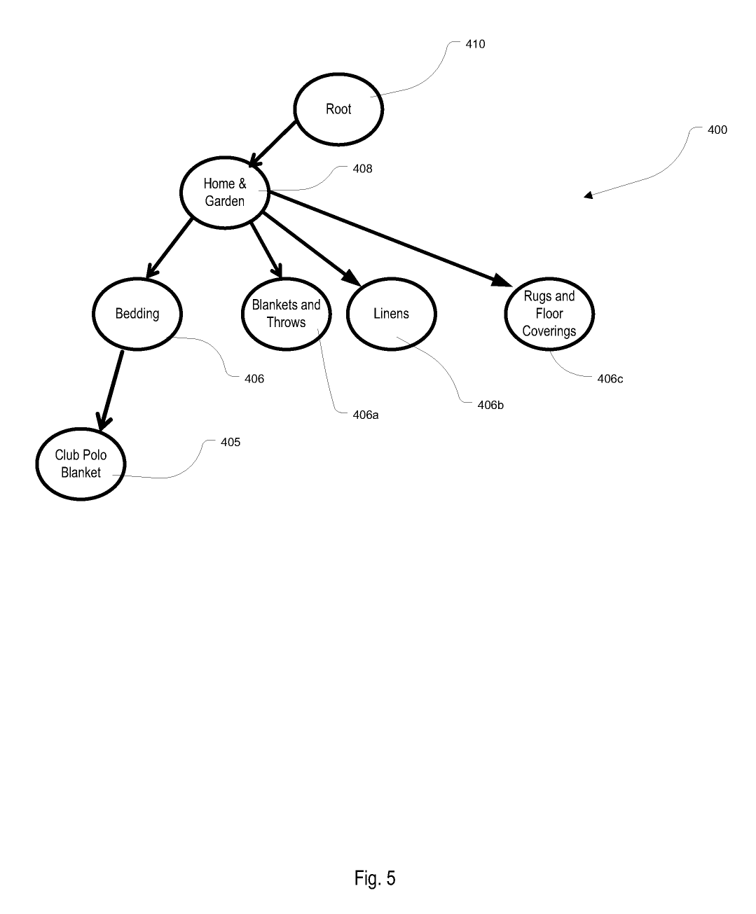

At 314, the system may determine other product types within the department to which the product may also be classified. The determination may be made through secondary classification models or may be made by searching within an existing hierarchy retrieved from memory within the merchant database. As is illustrated in FIG. 5, other product types that might include the “Club Polo Blanket” 405 are “Blankets and Throws” 406a and “Linens” 406b.

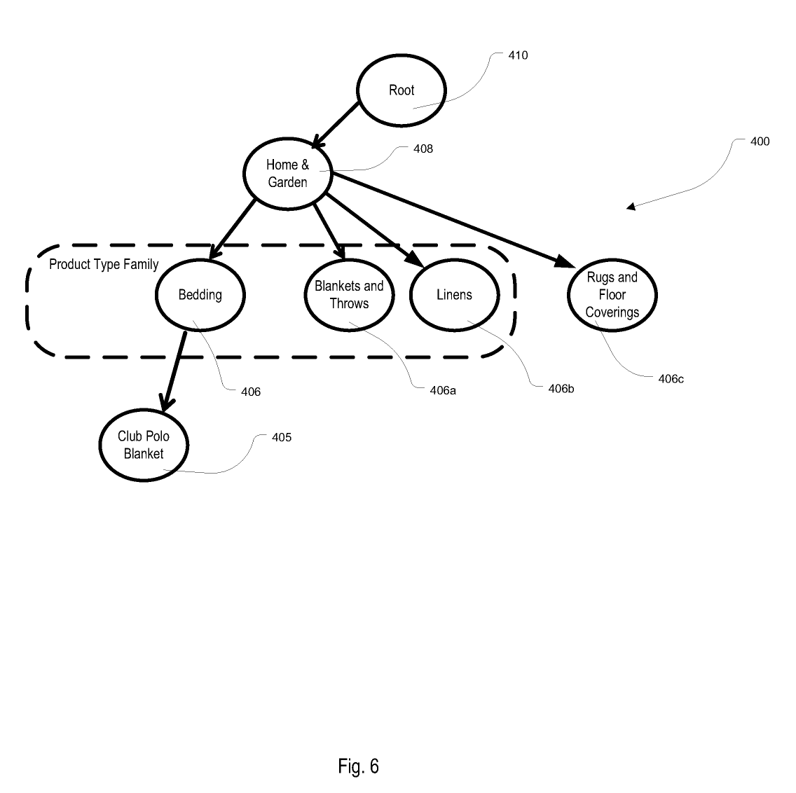

At 316, the other product types that may comprise the new product item as determined at 314, may be selected and grouped as a product type family as illustrated in FIG. 6 by the dashed box labeled Product Type Family. It should be noted that an implementation may traverse back up to the department level for a product type family determination. In other words a product type family may include product types from different departments within the hierarchy of the merchant database. It should be noted that the product type “Rugs and Floor Coverings” 406c as been found not to contain the “Cub Polo Blanket” 405 and so is not included in the product type family designation.

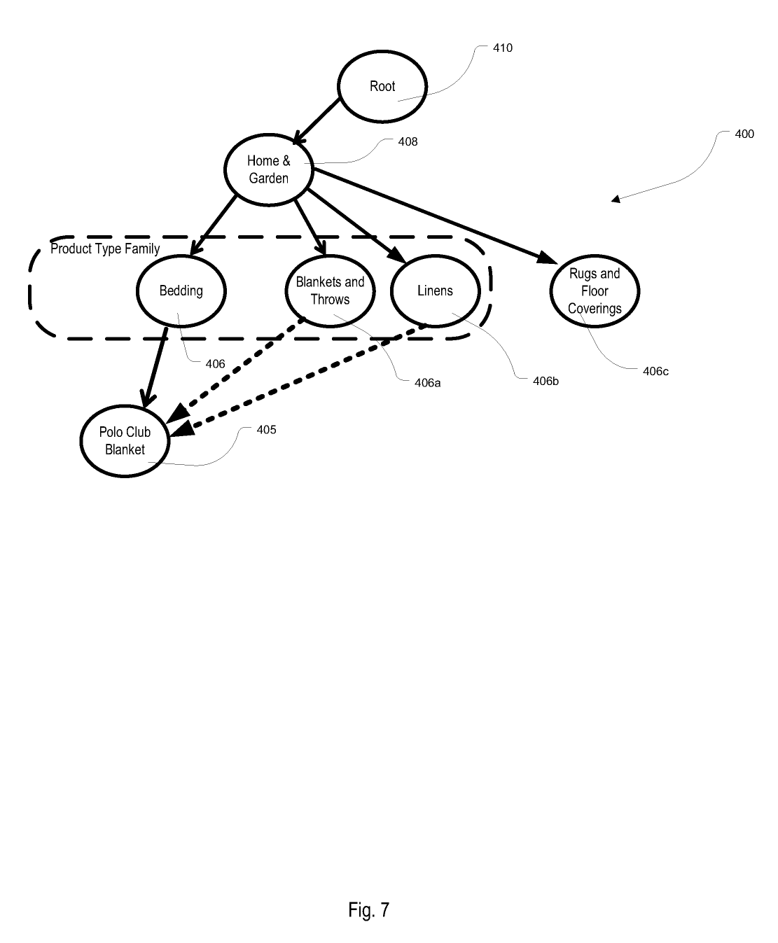

At 318, the new product item classification may be created and may be added to the merchant database and properly classified to include the other product types from within the product type family determined at 316. Additionally a hierarchy can be established to illustrate the product type additions in the new product classification as illustrated by the dashed arrows in FIG. 7. Additionally, the new product classification may be added to an existing hierarchy that comprises other merchant sold products.

Thus the disclosure provides a method and system for classifying new products and improving the classification of existing products within a merchant's database through the establishment of a hierarchy products and the designation of product family types within the hierarchy.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for classifying a new product item addition to a merchant's database of product offerings, comprising:
receiving over a computer system, product information;
classifying with a processor a department to which a new product item belongs;
classifying with a processor a product type for the new product item;
establishing with a processor a hierarchy comprising the new product item according to the product type of the new product item and the department to which the new product item belongs;
determining with a processor other product types to which the new product item belongs;
determining with a processor a product type family comprising other product types to which the new product item belongs; and
creating with a processor a classification for the new product item comprising the other product types from within the product type family.

2. A method according to claim 1, wherein the product type family comprises at least one other product type belonging to a different department.

3. A method according to claim 1, wherein the hierarchy is a top down hierarchy comprising:
a root level at the top of the hierarchy;
a product level at the bottom of the hierarchy; and
a product type level disposed between the root level and the product level.

4. A method according to claim 3, wherein determining other product types comprises traversing from the product level to the product type level.

5. A method according to claim 3, wherein determining other product types comprises traversing from the product level to the product type level then to the department level.

6. A method according to claim 1, further comprising receiving an existing hierarchy comprising existing product items that have been previously classified.

7. A method according to claim 6, further comprising adding the new product classification to the existing hierarchy.

8. A method according to claim 1, wherein the classification model is based on K-Nearest Neighbors.

9. A method according to claim 1, wherein the classification model is based on Naïve Bayes.

10. A method according to claim 1, wherein the classification model is based on logistic regression.

11. A method according to claim 1, where in the step of receiving over a computer system, product information, further comprises the step of receiving over a network, product information.

12. A system for updating a merchant's product database, comprising: one or more processors and one or more memory devices operably coupled to the one or more processors and storing executable and operational data, the executable and operational data effective to cause the one or more processors to:
receive over a network new product information;
classify with a processor a department to which a new product item belongs;
classify with a processor a product type for the new product item;
establish with a processor a hierarchy comprising the new product item according to the product type of the new product item and the department to which the new product item belongs;
determine with a processor other product types to which the new product item belongs;
determine with a processor a product type family comprising other product types to which the new product item belongs; and
create with a processor a classification for the new product item comprising the other product types from within the product type family.

13. A system according to claim 11, wherein the product type family comprises at least one other product type belonging to a different department.

14. A system according to claim 11, wherein the hierarchy is a top down hierarchy comprising:
a root level at the top of the hierarchy;
a product level at the bottom of the hierarchy; and
a product type level disposed between the root level and the product level.

15. A system according to claim 13, wherein determining other product types comprises traversing from the product level to the product type level.

16. A system according to claim 13, wherein determining other product types comprises traversing from the product level to the product type level then to the department level.

17. A system according to claim 11, further comprising: receive an existing hierarchy comprising existing product items that have been previously classified.

18. A system according to claim 11, further comprising: add the new product classification to the existing hierarchy.

19. A system according to claim 11, wherein the classification model is based on K-Nearest Neighbors.

20. A system according to claim 11, wherein the classification model is based on Naïve Bayes.

21. A system according to claim 11, wherein the classification model is based on logistic regression.
